(19) United States
(12) Patent Application Publication
(10) Pub. No.: US 2025/0320824 A1
(43) Pub. Date: Oct. 16, 2025

(54) TURBOMACHINE FOR A FLIGHT PROPULSION DRIVE

(71) Applicant: MTU Aero Engines AG, München (DE)

(72) Inventors: Simon Schuldt, München (DE); Istvan Bolgar, Sengenthal (DE); Milena Fois, Saint-Egreve (FR); Francois Cottier, Unterschleissheim (DE)

(73) Assignee: MTU Aero Engines AG, München (DE)

(21) Appl. No.: 19/169,657

(22) Filed: Apr. 3, 2025

(30) Foreign Application Priority Data
Apr. 9, 2024 (DE) 10 2024 109 829.5

(51) Int. Cl. F01D 25/30

(52) U.S. Cl. CPC F01D 25/30; F05D 2240/12; F05D 2250/232; F05D 2250/27; F05D 2250/712; F05D 2250/72; F05D 2260/213

(57) ABSTRACT

The invention relates to a turbomachine for a flight propulsion drive, comprising a core engine with a compressor, a combustion chamber, a turbine, and a heat exchanger downstream of the turbine, through which a gas flow can flow in a flow direction of the core engine, wherein, after the turbine, a flow guidance device is arranged, in order to guide the gas flow from the turbine outlet radially outward to a heat exchanger inlet, wherein the flow guidance device is arranged along the heat exchanger and defines a flow channel.

### BACKGROUND OF THE INVENTION

The invention relates to a turbomachine for a flight propulsion drive, comprising a core engine with a compressor, a combustion chamber, a turbine, and a heat exchanger downstream of the turbine, through which a gas flow passes in a flow direction, wherein a flow guidance device is arranged after the turbine in order to guide the gas flow from the turbine outlet radially outward to a heat exchanger inlet.

In order to improve the environmental impact of flight traffic, there exist efforts to utilize residual heat in propulsion turbomachines. In addition, the medium water or steam can be utilized to increase performance and to reduce emissions. For example, water-enhanced turbofan (WET) technology is based on an injection of water into a combustion chamber. It is thereby possible by means of exhaust-gas energy to generate steam in a steam generator arranged downstream of an engine turbine and to supply the steam in the region of the combustion chamber. After it has flowed through the steam generator, the moist exhaust gas can be passed through further components, which serve to separate water from the exhaust gas. Constraints on the utilization of such WET concepts are an efficient recovery of the water present in the exhaust gas and an efficiency-optimized utilization of the energy present in the exhaust gas of the turbomachine for the generation of steam from the recovered water. To this end, for example, it may be meaningful to guide the gas flow and the energy present in it to the steam generator with as little loss as possible and to ensure a uniform flow through the steam generator.

### SUMMARY OF THE INVENTION

Based thereon, an object of the present invention is to propose an improved turbomachine for a flight propulsion drive, in which, in particular, residual heat is to be utilized and efficiency shall be improved. This is achieved in accordance with the invention by the teaching of the independent claims. Advantageous embodiments of the invention are the subject of the dependent claims.

Proposed for the achievement of the objective is a turbomachine for a flight propulsion drive, comprising a core engine with a compressor, a combustion chamber, a turbine, and a heat exchanger downstream of the turbine, through which a gas flow passes in a flow direction. A flow guidance device is thereby arranged after the turbine in order to guide the gas flow from the turbine outlet radially outward to a heat exchanger inlet, wherein the flow guidance device is arranged along the heat exchanger and defines a flow channel, the cross section of which initially widens in the flow direction, so that the gas flow enters into a hot-gas region of the heat exchanger at an angle with respect to the flow direction. In other words, the flow guidance device acts simultaneously as a diffusor and as a deflection element for the flow.

In this way, the gas flow can be guided from the outlet out of the turbine or out of a low-pressure turbine of the turbine from the core engine to the heat exchanger in a reduced-loss manner. Typically, the outlet of a turbine has a circular ring-shaped cross section, with the flow guidance device being provided to guide this circular ring-shaped gas flow radially outward, in particular uniformly, over an axial length of the heat exchanger or the heat exchanger inlet, so that a uniform flow through the heat exchanger can be made possible. Accordingly, the gas flow can enter into a hot-gas region of the heat exchanger radially outward and thus at an angle in the range of up to 90° with respect to the flow direction or with respect to a rotational axis of the turbine or the core engine. Depending on the design of the hot-gas region of the heat exchanger, it may be advantageous if the gas flow enters into the heat exchanger at a predetermined angle with respect to the direction of flow. It is advantageous if the gas flow enters into the hot-gas region at an angle of 60° to 90° and, in particular, 80° to 90° with respect to the flow direction of the gas flow at the outlet of the turbine, which essentially corresponds to the direction of the rotational axis of the turbomachine.

The heat exchanger has a hot-gas region arranged in the direction of the gas flow after the heat exchanger inlet. The hot-gas region serves as the hot side of the heat exchanger from which heat is transferred to the cold side. As a rule, the cold side is separated from the hot side and a medium that absorbs heat from the hot-gas region passes through the cold side. In a first exemplary embodiment, this medium could be, for example, ram air or compressor bleed air. In another exemplary embodiment, at least one channel through which water can flow could be present and the gas flow is able to flow around it in order to transfer thermal energy from the gas flow to the water and thereby to vaporize it or to superheat the generated steam.

A turbomachine for a flight propulsion drive has a compressor, a combustion chamber, and a turbine, which form the core engine. Typically, during the operation of the turbomachine, ambient air is sucked in via a fan and compressed in the compressor, mixed with fuel, and ignited in the combustion chamber in order to drive the turbine. In addition, the proposed turbomachine has a heat exchanger arranged downstream of the turbine, in which, in particular, water that is removed from the gas flow or the exhaust gas of the turbomachine and provided to the heat exchanger is used to generate steam by using the energy of the gas flow. In addition, the turbomachine can have a fuel processing system that serves for processing the fuel prior to the combustion thereof in the combustion chamber and that can utilize the steam generated in the heat exchanger.

For the provision of this steam, the turbomachine can have an exhaust-gas treatment device, which can be arranged downstream of the turbine and can be set up to recover water present in the gas flow. To this end, the exhaust-gas treatment device can have the already described heat exchanger, a cooling device, and a water separation device, whereby the gas flow can pass through the heat exchanger, the cooling device, and the water separation device in succession. By means of the heat exchanger, energy for the generation of steam is drawn from the exhaust gas, as a result of which the temperature of the gas flow drops. The cooling device downstream of the heat exchanger is set up, in particular, to cool the gas flow even further, so that fractions of liquid water can be present in the exhaust gas flow and can be separated out of the exhaust-gas flow. The liquid water fraction can be separated from the gas flow in the water separation device and supplied to the heat exchanger or the steam generator, for example, by means of a feed device in order to generate steam from the water. At least a part of the steam generated in the heat exchanger can be mixed with the fuel, whereby the fuel vaporizes. In this way, the steam can be supplied to the fuel or to the gas flow prior to and/or in the combustion chamber. Accordingly, the water can be kept in circulation, as a result of which an additional water supply for the combustion process can be dispensed with.

In such a turbomachine, which, in particular, utilizes the WET concept, the heat exchanger takes on essentially two functions. On the one hand, energy is drawn from the gas flow, as a result of which the temperature of the gas flow decreases in order to enable recovery of water from the gas flow, and, on the other hand, this energy is utilized in order to vaporize the water, in particular the water removed from the gas flow, so as to enable this water to be available for combustion in the combustion chamber.

The invention is based on, among other things, the idea of providing a streamlined body as a flow guidance device after the turbine so as, in this way, to define the geometry of a flow channel for the flow. This flow guidance device can thereby be arranged, for example, axially with respect to a turbine outlet in order to influence the gas flow exiting there, in particular with respect to its flow direction. Owing to the initially widening and subsequently tapering geometry of the flow channel, it is possible to create a flow-conducting plenum in order to guide the gas flow to the heat exchanger or the vaporizer, in particular in a low-loss manner. Hereby provided is, in particular, a deliberate geometric contour of the flow guidance device in order for the flow course to be influenced favorably.

Inside of the flow channel to the heat exchanger created by the flow guidance device, at least one part of the gas flow can flow along the contour of the flow guidance device and thereby be influenced or guided with respect to its flow direction. In this way, it is made possible, in particular, to deflect the gas flow from its original axial flow direction and to guide it to the heat exchanger in a radial direction. In addition, it is possible by way of the flow conductance or flow guidance enabled by means of the flow guidance device to reduce thermal losses and/or pressure losses in the gas flow between the turbine (outlet) and the heat exchanger (inlet), so as, in this way, to create more efficiently a generation of steam or a superheating of the steam generated in the heat exchanger.

In one embodiment, the flow guidance device has at least one concave gas conduction surface. In this case, the gas conduction surface is arranged, in particular, on a side of the flow guidance device that faces the heat exchanger and, for example, can extend from the turbine outlet up to an axial end of the flow guidance device and/or the heat exchanger or the inlet region thereof. The flow guidance device can be designed in such a way that its cross section is initially reduced in the flow direction and then is increased, in particular in an end region of the flow channel, in such a way that the flow channel is axially bounded by the flow guidance device, whereby the flow guidance device can adjoin radially the heat exchanger or the inlet region thereof. In this way, it is possible, in particular over the entire course of the flow guidance device or of the flow channel, to deflect mass fractions of the gas flow in order for it to be able to enter the heat exchanger radially and thus at an angle with respect to the flow direction. In other embodiments, such a concave gas conduction surface forms an axial subregion of the flow guidance device.

In one embodiment, the flow guidance device forms a single-layer hyperboloid. Such a hyperboloid is typically a surface that is created by a complete rotation of a hyperbola around one of its axes. Here, the hyperboloid can be formed, in particular, in an axially asymmetric manner, whereby a curvature in the inlet region of the flow channel or upstream of the gas flow can be designed to be smaller than in an end region of the flow channel or in a downstream region of the flow guidance device. In this way, it is possible to achieve a low-loss flow conduction, in particular over the entire axial length of the flow guidance device.

In one embodiment, the flow guidance device forms a cone region that widens in the flow direction. Here, the flow guidance device in the cone region can have, at least in sections, a concave and/or convex curvature. Particularly in the inlet region of the flow channel and/or in the end region of the flow channel, a concave curvature of the flow guidance device can be provided, whereby this concave region or these concave regions, particularly each of them, can adjoin the cone region. Owing to a geometry that widens in the flow direction, it is possible to keep constant the flow speed of the gas flow or of the gas mass flow in the flow channel. In addition, the gas flow can be conducted radially outward owing to a widening in the cone region in order for it to enter the heat exchanger inlet and the hot-gas region of the heat exchanger.

In one embodiment with a widening cone region, an interior space can be created inside of the flow guidance device and, for example, can serve for a placement or arrangement of at least one further component and/or one further system of the turbomachine and/or of the flight propulsion drive.

In one embodiment, the flow guidance device has at least one gas conduction element. In this case, the gas conduction element can have a rotationally symmetrical design, such as, for example, a tubular geometry that, in particular, widens in the flow direction in a trumpet-like manner and, on its radial outer side, has a gas conduction surface. In other embodiments, a gas conduction element can be designed, for example, as a segment of such a tubular geometry or as a surface that is concavely formed, at least in sections, and is arranged in the flow channel. In this way, it is possible to achieve an additional directional orientation for the gas flow in order to enable it to be supplied to the heat exchanger or to the hot-gas region at an angle with respect to the flow direction of the turbomachine. In particular, it is possible for a plurality of such gas conduction elements to be arranged or fastened on a flow guidance device at a uniform or different spacing with respect to one another, particularly parallel with respect to one another, in order to make possible an additional flow guidance of the gas flow.

In one embodiment, the at least one gas conduction element has a concave gas conduction surface. In this case, the gas conduction surface can be formed on an outer circumference of a gas conduction element, that is, particularly rotationally symmetrical and essentially conical in design. In this way, the gas conduction surface can be designed in cross section, for example, as a circular arc segment, particularly as a circular arc segment with a vertical angle of 90°. One end of the gas conduction surface that faces the turbine outlet can thereby be aligned so as to be essentially parallel with respect to the flow direction of the turbine and one end of the gas conduction surface that faces away from the turbine outlet can be aligned radially outward, in particular at an angle of up to 90° with respect to the initial flow direction, in order to be able to guide the gas flow towards a heat exchanger, particularly a heat exchanger that is arranged radially outward.

In one embodiment, the at least one gas conduction element is arranged coaxially with respect to the gas conduction surface of the flow guidance device. In this way, the gas conduction element can be arranged directly on the gas conduction surface of the flow guidance device or else can be arranged at a spacing with respect to it and/or, in particular, surround it at a particular spacing. For example, a gas conduction element can also have at least one recess, which defines a through-flow opening, so that the gas flow can pass through an intermediate space between the respective gas conduction element and the flow guidance device and/or the at least one recess. In this way, the gas flow can be guided in a defined manner, so that a flow guidance, particularly a uniform flow guidance, can be achieved over the entire cross section and/or an entire length of the flow channel.

In one embodiment, the flow guidance device has a plurality of gas conduction elements, each of which forms enlarged gas conduction surfaces in the flow direction. In this way, it is possible for a geometry, a radial dimension, a spacing, and/or a radius of curvature of an individual gas conduction element to be designed in such a way and/or a plurality of gas conduction elements to be designed in accord with one another in such a way that each of the gas conduction elements can divert a predetermined mass flow fraction—for example, an essentially identical mass flow fraction—from the gas flow in order to deflect it at an angle radially outward and thus supply it to the heat exchanger. In this way, it is possible to achieve a desired conduction—for example, a uniform conduction—of the gas flow to the heat exchanger over the axial length thereof.

In one embodiment, the flow guidance device is rotationally symmetrical in design. The gas flow can thereby flow, for example, along the outer or circumferential side of the flow guidance device in order to be deflected from the original axial flow direction and enter the heat exchanger or the hot-gas region thereof radially outward at an angle. In this way, the flow guidance device can extend, in particular rotationally symmetrically, around the rotational axis of the turbomachine, as a result of which a flow that is created uniformly in the circumferential direction can be achieved for the cross section, particularly for the circular ring-shaped cross section, of the gas flow.

In one embodiment, the heat exchanger and/or the hot-gas region of the heat exchanger is or are designed, at least in sections, to be rotationally symmetrical. In this way, the inlet region of the heat exchanger can be designed to be circular in shape and, in particular, the hot-gas region of the heat exchanger can have an essentially circular ring-shaped cross section, which is arranged coaxially with respect to the flow channel or which surrounds it in the circumferential direction or surrounds it in sections. In this way, the vaporizer or the heat exchanger can radially surround or enclose the turbine outlet or the gas flow exiting from it, in order to create the flow channel. In this way, it is possible, particularly through the avoidance of losses due to (deflected) conduction, to achieve a flow-favorable and low-loss gas flow guidance.

In one embodiment, the heat exchanger or the hot-gas region of the heat exchanger is designed to be planar. In this way, it is possible to arrange one planar-designed heat exchanger or a plurality of planar-designed heat exchangers radially around the exiting gas flow and to create one flow guidance device or a plurality of flow guidance devices and one flow channel or a plurality of flow channels, which, in particular, can have circular ring-segment-shaped cross sections. In this way, a flow guidance device that is formed in a circular ring-segment shape in cross section, for example, can be assigned to a planar-designed heat exchanger, in order to guide to the latter a circular ring-segment-shaped fraction of the gas flow exiting from the turbine. A planar design is also to be understood as a design for which the entry region facing the gas flow particularly has a shape that is favorable for the flow or is curved.

In one embodiment, the flow guidance device is formed on the heat exchanger. Accordingly, the flow guidance device forms a part of the heat exchanger. In this way, a flow guidance between the flow guidance device and the heat exchanger can be improved, because the flow guidance device is designed to be adapted directly to the heat exchanger and thus the heat exchanger and the flow guidance device can have geometries and/or cross sections that are matched to each other. In addition, one end of the flow channel can be closed by a connection between the flow guidance device and the heat exchanger, in order to thereby improve flow guidance. In some embodiments, it is possible to arrange at least one flow guidance device on the turbine outlet, as a result of which the geometry of a heat exchanger can be adapted freely to the design space that is available.

Proposed in accordance with a further aspect is a method for operating a turbomachine for a flight propulsion drive, comprising a core engine with a compressor, a combustion chamber, a turbine, and a heat exchanger downstream of the turbine, through which a gas flow can flow in the flow direction of the core engine, wherein, after the turbine, a flow guidance device is arranged, which defines a flow channel along the heat exchanger, the cross section of which initially widens in the flow direction and then is reduced, so that the gas flow enters a hot-gas region of the heat exchanger at an angle with respect to the flow direction, comprising steps of the flow of gas through the core engine, the deflection of the gas flow by means of the flow guidance device, and the flow of gas through the heat exchanger. In this way, the effects and advantages specified in the scope of the present description can be utilized.

Further features, advantages, and possible uses of the disclosure ensue from the following description in conjunction with the figures. In general, it holds that features of the different aspects and/or embodiments described herein can be combined with one another, insofar as this is not ruled out explicitly in connection with the disclosure.

### BRIEF DESCRIPTION OF THE DRAWING FIGURES

In the following part of the description, reference is made to the figures, which are shown in order to highlight specific aspects and embodiments of the present disclosure. It is obvious that other aspects can be used and structural or logical changes in the illustrated embodiments are possible, without leaving the scope of the present disclosure. The following description of the figures is therefore to be understood as non-limiting. Shown herein are:

FIG. 1 shows a schematic illustration of an exemplary turbomachine according to the invention for a flight propulsion drive;

FIG. 2A shows a schematic illustration of a first exemplary embodiment of a heat exchanger and of a flow guidance device of a turbomachine in accordance with an exemplary embodiment of the present disclosure;

FIGS. 2B and 2C, in each case, show a schematic illustration of a second exemplary embodiment of a heat exchanger and of a flow guidance device of a turbomachine in accordance with an exemplary embodiment of the present disclosure;

FIG. 3 shows a schematic illustration of a third exemplary embodiment of a heat exchanger and of a flow guidance device of a turbomachine in accordance with an exemplary embodiment of the present disclosure;

FIG. 4 shows a schematic illustration of a fourth exemplary embodiment of a heat exchanger and of a flow guidance device of a turbomachine in accordance with an exemplary embodiment of the present disclosure; and

FIG. 5 shows a schematic flow chart of a method for operating a turbomachine in accordance with an exemplary embodiment of the present disclosure.

### DESCRIPTION OF THE INVENTION

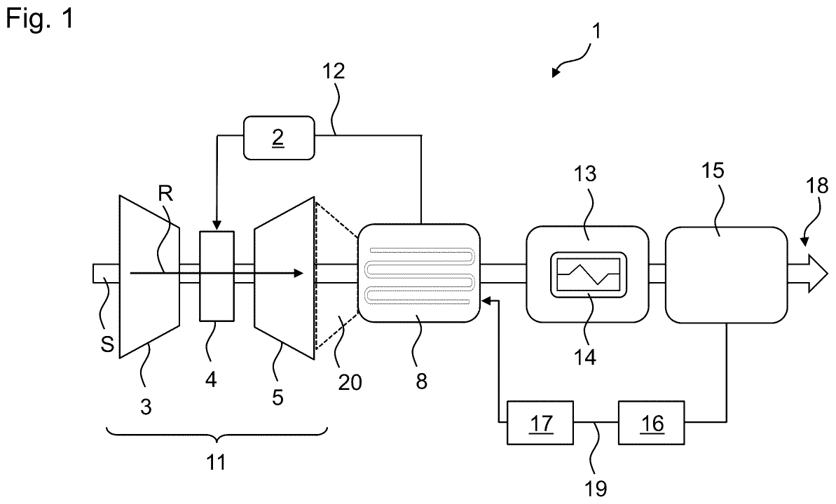

FIG. 1 shows an exemplary turbomachine 1 according to the invention for a flight propulsion drive in a schematic illustration.

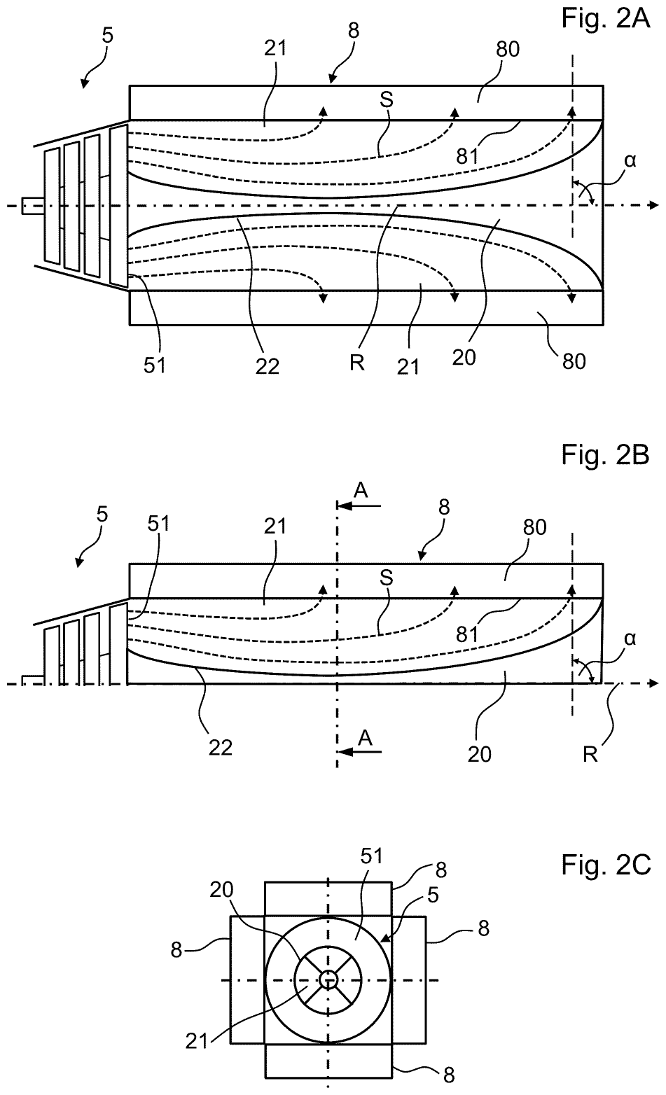

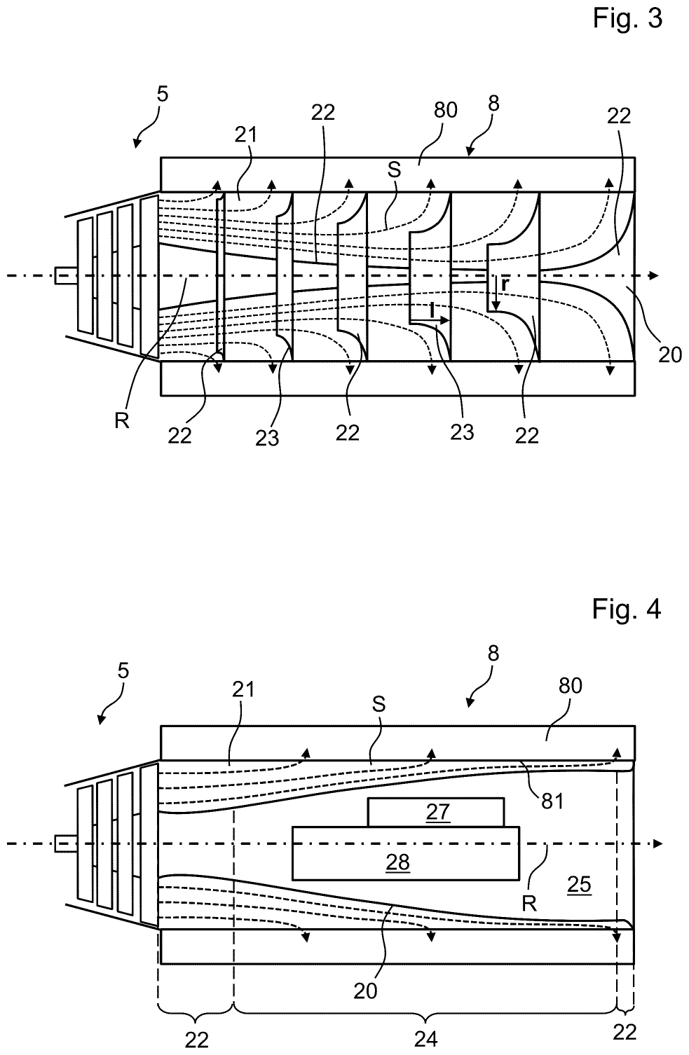

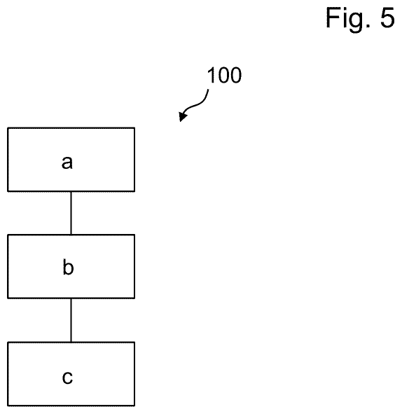

The turbomachine 1 has, by way of example, a core engine 11 with a compressor 3, a combustion chamber 4, and a turbine 5, through which a gas flow S can flow in a flow direction R of the turbomachine 1 or, during operation of the turbomachine 1, through which the gas flow S flows. Downstream of the turbine 5 in the flow direction R, the turbomachine 1 has a heat exchanger 8, which is set up to generate steam from a water by means of an energy of the gas flow S. Arranged here after the turbine 5 is a flow guidance device 20, which is set up to guide the gas flow S from the turbine outlet radially outward to a heat exchanger inlet of the heat exchanger 8. The schematic representation shown does not show the specific geometric arrangement, but is intended merely to illustrate the way the turbomachine functions as a whole. The flow guidance device 20 as well as the heat exchanger 8 are described in detail below in conjunction with the FIGS. 2A-C, FIG. 3, FIG. 4, and FIG. 5.

The steam generated by means of the heat exchanger 8 can be fed via a steam feed 12, in particular together with a fuel, into the gas flow S for combustion in the combustion chamber 4. The steam feed 12 can have a mixing chamber 2 of a fuel processing device, in which fuel is introduced and can be fed in this way to the steam that is guided through the mixing chamber 2, whereby the fuel can vaporize. In other embodiments, the steam can also be supplied to the fuel or to the gas flow S prior to and/or in the combustion chamber 4.

In relation to the global flow direction R of the gas flow S, illustrated by an arrow, particularly in the core engine 11, after the heat exchanger 8, the gas flow S can be passed through a cooling device 13 and a water separation device 15, which are arranged downstream of the heat exchanger.

The cooling device 13 is set up to cool the gas flow in order to make possible a separation of the water contained in the gas flow S. Arranged downstream of the cooling device 13 in the present exemplary embodiment is a water separation device 15 in order to separate out and collect the water from the gas flow. The remaining gas flow S can leave the turbomachine 1 via an outlet 18 and, in particular, can be expelled to the surroundings.

The separated water can, for example, be passed into a water reservoir 17 via an optionally present water processing system 16, where it can be available for a further use. By means of a feed device 19, the water can be made available to the heat exchanger 8 in order to use energy of the gas flow S to generate steam therein, which can be fed to the gas flow S in the region of the combustion chamber 4.

FIG. 2A shows a schematic sectional illustration of a first exemplary embodiment of a heat exchanger 8 and of a flow guidance device 20, such as they can be provided in a turbomachine 1 of FIG. 1.

Illustrated in FIG. 2A is a section of the turbine 5 and the heat exchanger 8 of the turbomachine 1 in a sectional illustration along the rotational axis of the turbomachine 1 or of the core engine 11. Arranged in the flow direction R after the turbine 5 is the flow guidance device 20 for guiding the gas flow S from the turbine outlet 51 radially outward to a heat exchanger inlet 81. In the illustrated exemplary embodiment, both the heat exchanger 8 and the flow guidance device 20 are rotationally symmetrical in design and are arranged coaxially with respect to the rotational axis of the turbine 5 or of the turbomachine 1.

The flow guidance device 20 is designed and arranged in such a way that, along and together with the heat exchanger(s) 8, it defines a flow channel 21, the cross section of which initially widens in the flow direction R and then is reduced, so that the gas flow S is guided radially outward and enters a hot-gas region 80 of the heat exchanger 8 at an angle α with respect to the flow direction R. The angle here can be up to 90° in relation to the flow direction R, whereby the gas flow S at a =90° can enter the heat exchanger 8 essentially perpendicularly with respect to the flow direction R.

In the illustrated exemplary embodiment, the flow guidance device 20 forms a single-layered hyperboloid, as a result of which the flow guidance device 20 has a concavely curved gas conduction surface 22 in order to guide the gas flow radially outward in the direction of the heat exchanger 8. In the exemplary embodiment, the gas conduction surface 22, which is adjacent to the turbine outlet and thus is adjacent to the entry of the gas flow into the flow guidance device 20, has a smaller radius of curvature than in a following region in order to conduct the gas flow S into the heat exchanger 8 as uniformly as possible over the axial course thereof.

FIG. 2B shows a schematic sectional illustration of a second exemplary embodiment of a heat exchanger 8 and of a flow guidance device 20, such as they can be provided in a turbomachine 1 of FIG. 1. The heat exchanger 8 of the second exemplary embodiment or, in particular, the heat exchanger inlet 81 of the heat exchanger 8 here has a planar design.

One planar-designed heat exchanger 8 or a plurality of planar-designed heat exchangers 8 can be arranged radially spaced apart with respect to a rotational axis of the turbomachine, whereby the flow guidance device 20 is set up to guide the gas flow S or a part of the gas flow S radially outward and at an angle α with respect to the heat exchanger or the heat exchangers. In this case, the (individual) flow guidance device 20 can be set up and arranged on the turbine 5 or the turbine outlet 51 in such a way that it can take up a fraction, in particular a predetermined fraction, of the entire gas flow S exiting out of the turbine 5 in order to guide it to the respective heat exchanger 8. In this way, it is possible for a plurality of flow guidance devices 20 to be arranged adjoined to one another, at least in part, in the circumferential direction.

FIG. 2C shows a further schematic sectional illustration of the second exemplary embodiment of the heat exchanger 8 and of the flow guidance device 20 from FIG. 2B in a section cut along the line A-A of FIG. 2B.

Illustrated are four heat exchangers 8, which are arranged in uniform distribution around the rotational axis of the turbomachine 1 and which each create, together with a flow guidance device 20, a flow channel 21, the cross section of which initially widens in the flow direction R and then is reduced in order to guide the respective fraction of the gas flow S to the heat exchanger 8 at an angle α.

FIG. 3 shows a schematic sectional illustration of a second exemplary embodiment of a heat exchanger 8 and of a flow guidance device 20, as they can be provided in a turbomachine 1 of FIG. 1. The illustration of FIG. 3 corresponds in large parts to the illustration of FIG. 2A, for which reason only differences are addressed below.

In the flow channel created between the flow guidance device 20 and the heat exchanger 8, a plurality of gas conduction elements 23 are arranged, each of which, in the flow direction R, forms enlarged gas conduction surfaces 22. These gas conduction surfaces 22 are also concave in design, whereby, in regard to their relative arrangement with respect to one another, their through-flow radii r, their axial lengths l, and/or the radii of curvature of the gas conduction surfaces 22, the gas conduction elements 23 are formed, in particular, in such a way that each of the gas conduction elements 23 can conduct a fraction of the gas flow S into a hot-gas region 80 of the heat exchanger 8 at an angle α with respect to the flow direction R.

Such gas conduction elements 23 can also be employed, for example, in exemplary embodiments that have a planar-designed heat exchanger 8.

FIG. 4 shows a schematic sectional illustration of a fourth exemplary embodiment of a heat exchanger 8 and of a flow guidance device 20, as they can be provided in a turbomachine 1 of FIG. 1. The illustration of FIG. 4 corresponds in large part to the illustration of FIG. 2A or FIG. 3, for which reason only differences are addressed below.

In the illustrated exemplary embodiment, the flow guidance device 20 forms a cross section for the flow channel 21 that, in the flow direction R, initially widens and then is reduced. Subsequent to this concave curvature of the gas conduction surface 22 of the flow guidance device 20, the flow guidance device 20 forms a cone region 24 that widens in the flow direction R, whereby it has a convex curvature in the illustrated exemplary embodiment. In the downstream end region of the flow channel 21, a further concave curvature 22 of the flow guidance device 20 connects to the cone region 24, which, finally, ends at the inner circumference of the heat exchanger 8. Owing to the widening of the cone region 24, the gas flow is guided radially outward in order to enter the heat exchanger inlet 81. In other exemplary embodiments, a corresponding design of the flow guidance device 20 is equally possible in conjunction with a planar-designed hot-gas region 80 of the heat exchanger 8. In this embodiment, an interior space 25 is created inside of the flow guidance device 20 or the widening cone region 24 thereof, in which further components 27 and/or further systems 28 of the turbomachine 1 can be arranged.

FIG. 5 shows, by way of example, a flow chart for a method 100 according to the invention for operating a turbomachine 1 for the flight propulsion drive from FIG. 1 in a schematic illustration.

In a first step a, the gas flow S flows through the core engine 11. In this case, the gas flow S is usually sucked in by means of a fan from the surroundings and flows in succession through the compressor 3, the combustion chamber 4, and the turbine 5. In a further step b, the gas flow S is deflected by means of the flow guidance device 20. To this end, the flow guidance device 20, together with the heat exchanger 8, creates the flow channel 21, into which the gas flow S flows in from the turbine outlet 51 and is deflected radially outward therein. In a step c, the gas flow S flows through the heat exchanger 8 in order to deliver energy to the water passed through the heat exchanger 8, so as to generate a steam and/or to superheat a steam.

1. A turbomachine for a flight propulsion drive, comprising:
a core engine with a compressor, a combustion chamber, a turbine, and a heat exchanger downstream of the turbine, through which a gas flow flows in a flow direction of the core engine,
wherein, after the turbine, a flow guidance device is arranged in order to guide the gas flow from the turbine outlet radially outward to a heat exchanger inlet, wherein the flow guidance device is arranged along the heat exchanger and defines a flow channel, the cross section of which widens in the flow direction, and which is configured and arranged so that the gas flow enters into a hot-gas region of the heat exchanger at an angle with respect to the flow direction.

2. The turbomachine according to claim 1, wherein the flow guidance device has at least one concave gas conduction surface.

3. The turbomachine according to claim 1 , wherein the flow guidance device forms a single-layered hyperboloid.

4. The turbomachine according to claim 1, wherein the flow guidance device forms a cone region that widens in the flow direction.

5. The turbomachine according to claim 1, wherein the flow guidance device has at least one gas conduction element.

6. The turbomachine according to claim 5, wherein the at least one gas conduction element has a concave gas conduction surface.

7. The turbomachine according to claim 5, wherein the at least one gas conduction element is arranged coaxially with respect to the gas conduction surface of the flow guidance device.

8. The turbomachine according to claim 1, wherein the flow guidance device has a plurality of gas conduction elements, each of which forms an enlarged gas conduction surface in the flow direction).

9. The turbomachine according to claim 1, wherein the flow guidance device is rotationally symmetrical in configuration.

10. The turbomachine according to claim 1, wherein the heat exchanger and/or the hot-gas region of the heat exchanger, at least in sections, is or are rotationally symmetrical in configuration.

11. The turbomachine according to claim 1, wherein the heat exchanger and/or the hot-gas region of the heat exchanger are planar in configuration.

12. The turbomachine according to claim 1, wherein the flow guidance device is formed on the heat exchanger.

13. A method for operating a turbomachine for a flight propulsion drive, comprising a core engine with a compressor, a combustion chamber, a turbine, and a heat exchanger downstream of the turbine, through which a gas flow flows in a flow direction of the core engine, wherein, after the turbine, a flow guidance device is arranged to guide the gas flow from the turbine outlet radially outward to a heat exchanger inlet, wherein the flow guidance device is arranged along the heat exchanger and defines a flow channel, the cross section of which initially widens in the flow direction and then is reduced, so that the gas flow enters into a hot-gas region of the heat exchanger at an angle with respect to the flow direction, comprising the following steps of:
a) providing flow of the gas flow through the core engine,
b) deflecting the gas flow the flow guidance device,
c) providing flow of the gas flow through the heat exchanger.
